(19) United States
(12) Patent Application Publication
(10) Pub. No.: US 2012/0104329 A1
(43) Pub. Date: May 3, 2012

(54) METHOD FOR DISPERSING GRAPHITE-LIKE NANOPARTICLES

(75) Inventors: Helmut Meyer, Odenthal (DE); Gesa Behnken, Koln (DE); Julia Hitzbleck, Koln (DE); Rudolf Zentel, Nierstein (DE); Stefan Meuer, Worms (DE)

(73) Assignee: Bayer MaterialScience AG, Leverkusen (DE)

(21) Appl. No.: 13/255,713

(22) PCT Filed: Mar. 5, 2010
(86) PCT No.: PCT/EP10/01393

§ 371 Date: Jan. 9, 2012

(30) Foreign Application Priority Data
Mar. 13, 2009 (DE) 10 2009 012 675.9

(51) Int. Cl. H01B 1/24; B82Y 30/00

(52) U.S. Cl. 252/511; 977/773; 977/932

(57) ABSTRACT

A method for dispersing graphite-like nanoparticles is described, wherein the graphite-like nanoparticles are dispersed in a continuous liquid phase while applying energy in the presence of the dispersing agent, using dispersing agents consisting of block copolymers, at least one block of which bears aromatic side chains that are bound via aliphatic chain links to the main chain of the block copolymer.

The invention is based on known methods for dispersing graphite-like nanoparticles in which the graphite-like nanoparticles are dispersed in a continuous liquid phase with introduction of energy in the presence of the dispersing auxiliary.

The invention relates to the use of dispersing agents for dispersing carbon-based nanoparticles comprising block copolymers, at least one block of which carries aromatic side chains which are bonded to the main chain via aliphatic chain members.

Functional polymer composites open up completely novel possibilities in the development of materials. By addition of nanoscale fillers, the profile of properties of polymers can be decidedly improved and extended. A major problem for effective use of such nanoparticles, however, is their dispersibility, since they are strongly attracted to one another via van der Waals forces and due to their preparation are present in a form in which they are highly aggregated in one another and agglomerated.

In the more recent past more and more attempts have been made to develop suitable dispersing agents. However, to date no dispersing agents which are also sufficiently active at higher concentrations and in organic solvents have yet been found for carbon-based nanoparticles. Islam et al., Nanoletters, 3, 269-273, 2003, achieved concentrations of up to 20 mg/l using sodium dodecylbenzylsulfonate in aqueous dispersions of SWNT. Wenseleers et al., Adv. Funct. Mater. 14, 1105-1112, 2004, compared many different dispersing agents with one another, but were not able to realize higher concentrations. However, such dispersions are scarcely suitable for introducing nanoparticles into polymers.

Organic dispersions are necessary for such uses. The spectrum of the methods employed to date includes chemical functionalization of the nanoparticles as reported by Sun et al., J. M. Tour, Chem. Eur. J., 10, 812-817, 2004, or the covalent bonding to monomer units, oligomers or polymers, as has been described by Tasis et al., Chem. Eur. J., 9, 4000-4008, 2003. As an alternative to this, Szleifer et al., Polymer, 46, 7803, 2005 monitored the adsorption of charged surfactants and polyelectrolytes on CNTs, while Rouse, Langmuir, 21, 1055-1061, 2005 considered the enclosing of CNTs with polymers and Chen et al., J. Am. Chem. Soc. 123, 3838, 2001 considered complexing by π-π interactions.

A major disadvantage of chemical functionalization of carbon nanotubes and the associated covalent bonding to the outermost graphite layer of the nanoparticles, however, is that the electronic structure of the CNT is modified by these methods and a change, which as a rule is undesirable, thus occurs in the physical or chemical properties, and in particular also the electrical conductivity. Dispersing auxiliaries with . . . which contain pyrenes are known per se and have already been employed by Lou et al., Chem. Mater. 16, 4005-4011, 2004, and by Bahun et al., J. Polym. Sci. Part A: Polym. Chem. 44, 1941-1951, 2006 as an addition in organic solvents for dispersing carbon nanotubes. However, these dispersing auxiliaries were not very effective in the organic solvents and only a low solubility (i.e. finely disperse solution) of the CNT up to a maximum of 0.65 mg/ml in THF was achieved.

A similarly poor dispersing action was achieved in EP 1965451A1 with dispersing auxiliaries which comprise an aromatic head, which forms the main chain, and an aliphatic tail, which forms the side chain. In US 20070221913A1 dispersing agents which are based on aromatic imides or polyvinylpyrrolidones and which thus contain the aromatic functionalities exclusively in the main chain were developed. These dispersing agents also were not very effective with respect to the dispersing success for graphite-like nanoparticles.

The object of the invention is to develop highly effective dispersing agents with which graphite-like nanoparticles can be dispersed in organic solvents and stabilized.

It has been found, surprisingly, that block copolymers, at least one block of which carries aromatic side chains which are bonded to the main chain via aliphatic chain members, can be employed as highly effective dispersing agents for carbon nanotubes and other graphite-like nanoparticles, such as e.g. graphenes or nanographites built up in layers or carbon nanofibres, in organic solvents. The choice of block lengths and side chains is of decisive importance here for a high dispersing effectiveness.

A number of aromatic anchor groups of two or more is preferable, in order to increase the affinity for the surface of the graphite-like nanoparticles. Furthermore, the length of the aliphatic chain members between the main chain and aromatic anchor group is important for the activity of the dispersing agent, as is the length of the soluble polymer block.

The invention provides a method for dispersing graphite-like nanoparticles, in which the graphite-like nanoparticles are dispersed in a continuous liquid phase with introduction of energy in the presence of the dispersing auxiliary, characterized in that dispersing auxiliaries based on block copolymers are used, wherein the block copolymers have polymer blocks E) without a side chain and at least one polymer block A) with side chains B) which contain aromatic groups D) and are bonded to the main chain of block A) via aliphatic chain members C).

Preferably, a dispersing auxiliary in which the length of the block A) with aromatic side chains B) includes at least five monomer units from the group of vinyl polymers, in particular polyacrylates, polymethacrylates, polyacrylic acid, polystyrene, and polyesters, polyamides, polycarbonates or polyurethanes, is employed.

Dispersing auxiliaries with aromatic side chains B) which are based on at least one mono- or polynuclear aromatic D), in particular a C₅- to C₃₂-aromatic optionally substituted by amino groups, preferably a C₁₀- to C₂₇-aromatic optionally substituted by amino groups, wherein the aromatics optionally contain hetero atoms, in particular one or more hetero atoms of the series nitrogen, oxygen and sulfur, are preferred.

The aliphatic chain members C) in the dispersing auxiliary are preferably formed by a C₁- to C₁₀-alkyl chain, in particular by a C₂- to C₆-alkyl chain.

The polynuclear aromatic D) of the aromatic side chains B) is preferably a pyrene derivative.

In a preferred method, the block copolymer E) in the dispersing auxiliary is based on polymer from the group of vinyl polymers, in particular polyacrylates, polymethacrylates, polyacrylic acid, polystyrene, and polyesters, polyamines and polyurethanes.

In a particularly preferred embodiment of the invention, the blocks E) of the dispersing auxiliary which are free from side chains are built up from 50 to 500, preferably 100 to 200 monomer units from the series of the acrylates or methacrylates, and the blocks A) of the dispersing auxiliary which contain side chains are built up from 5 to 100, preferably 10 to 80 monomer units from the series of the substituted acrylates or methacrylates.

The graphite-like nanoparticles preferably have a diameter in the range of from 1 to 500 nm, and preferably a diameter in the range of from 2 to 50 nm.

The graphite-like nanoparticles are particularly preferably single- or multilayered graphite structures.

Particularly preferably, the single- or multilayered graphite structures are in the form of graphenes or carbon nanotubes or mixtures thereof.

A method which is furthermore preferred is characterized in that an organic solvent or water or a mixture thereof is used as the continuous liquid phase.

The organic solvent is preferably chosen from the group of mono- or polyfunctional, straight-chain, branched or cyclic alcohols or polyols, aliphatic, cycloaliphatic or halogenated hydrocarbons, linear and cyclic ethers, esters, aldehydes, ketones or acids and amides and pyrrolidone, or is particularly preferably tetrahydrofuran.

The invention further provides dispersing agents for carbon-based nanoparticles in organic solvents prepared by the method according to the invention.

The invention also provides the use of the abovementioned dispersion as a printable ink which contains organic solvents, for the production of electrically conductive structures or coatings.

Graphite-like nanoparticles in the context of this invention are at least: single-walled, double-walled or multi-walled carbon nanotubes (CNT), carbon nanofibres in a fishbone or platelet structure or also nanoscale graphites or graphenes, such as are accessible e.g. from highly expanded graphites.

The dispersing agents are preferably block copolymers of at least two different blocks, at least one block A) of which carries aromatic side chains bonded to the main chain via aliphatic chain members C) (also called spacers).

In this context, the polymer block E) can be built up from known monomer units, in particular the acrylates and methacrylates, which can carry, in particular, the following substituents:

hydrogen; C₁-C₅-alkyl, in particular methyl, ethyl, propyl, butyl, pentyl, hexyl, in straight-chain and branched form; aryl, in particular phenyl, which is optionally substituted by C₁- to C₄-alkyl radicals.

The polymers can furthermore also be built up by polyaddition or polycondensation. Polycarbonates, polyamides, polyesters and polyurethanes and combinations thereof, for example, are obtained in this way. Examples include polyamide from adipic acid and hexamethylenediamine (PA 6,6), poly(6-aminohexanoic acid) (PA 6), polyester from dimethyl terephthalate and ethylene glycol (PET), polycarbonate from carbonic acid, polycarbonate from diethyl carbonate or phosgene and bisphenol A, polyurethane from carbamic acid, polyurethane from isocyanates and diverse components which are at least difunctional, such as alcohols and amines.

The use of dispersing agents with polyacrylates or acrylic acid polymers in the main chain is preferred, and the use of dispersing agents based on polymethyl methacrylate, which have a good affinity for a large number of various solvents, is very particularly preferred. The block copolymer furthermore carries side chains, which can preferably be covalently bonded to the main chain via a reactive ester monomer, particularly preferably pentafluorophenyl methacrylate. The covalent bonding of the aromatic side chains to the main chain in this context is preferably via an amide function. Preferably, the amine compounds shown below are employed for incorporation of the aromatic group:

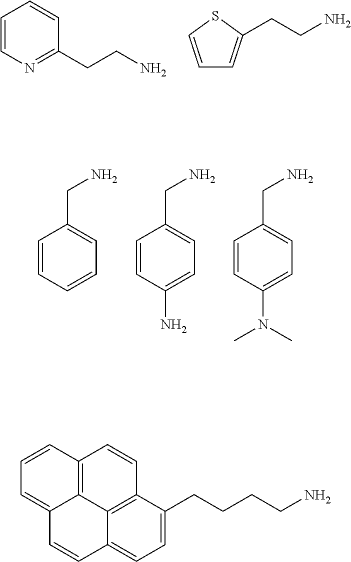

Further possible compounds are the derivatives of the compounds shown below, these carrying, analogously to the abovementioned particularly preferred compounds, at least one alkyl side group, at least one of which carries a primary amino function.

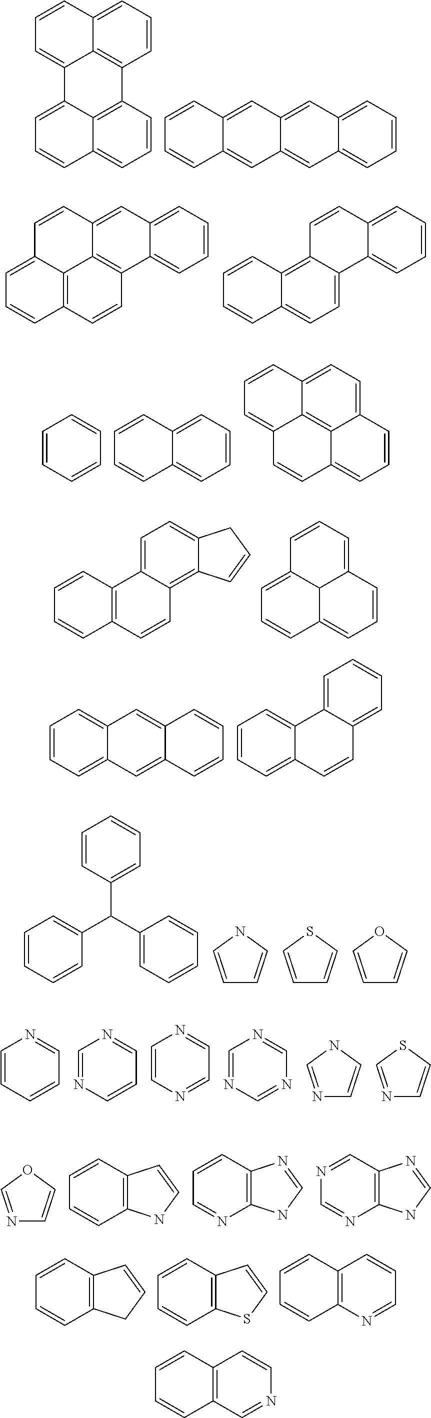

The preparation of the block copolymers for the dispersing agent is preferably carried out via a “reversible addition-fragmentation chain transfer polymerization” (RAFT). The desired block copolymers can be built up in a controlled manner by this means.

In particular, the dispersing auxiliaries according to the invention can be prepared in a controlled manner with a defined block length and defined aromatic side chains via this type of polyreaction.

With the aid of such dispersing auxiliaries, the graphite-like nanoparticles can be dispersed simply and effectively in many different solvents and, where appropriate, organic monomers. Preferred solvents for the carbon-based nanoparticles are organic solvents, for example ethers, in particular cyclic and acyclic ethers, particularly preferably tetrahydrofuran, dioxane, furan and polyalkylene glycol dialkyl ethers, straight-chain, branched or cyclic monofunctional or polyfunctional alcohols, such as, in particular, methanol, ethanol, propanol, butanol, ethylhexanol, decanol, isotridecyl alcohol, benzyl alcohol, propargyl alcohol, oleyl alcohol, linoleyl alcohol, oxo alcohols, neopentyl alcohol, cyclohexanol, fatty alcohols, or di- and polyols, such as glycol, ether alcohols, such as, in particular, 2-methoxyethannol, monophenyl diglycol, phenylethanol, ethylene glycol, propylene glycol, hydrocarbons, such as, in particular, toluene, xylene and aliphatic and/or cycloaliphatic benzine fractions, heteroaromatics, such as, in particular, piperidine, pyridine, pyrrole, chlorinated hydrocarbons, such as, in particular, chloroform and trichloroethane, tetrachloroethene, carbon tetrachloride, 1,1,1-trichloroethane, trichloroethene, or carboxylic acid esters, in particular monocarboxylic acid esters, such as, in particular, ethyl acetate and butyl acetate, or di- or polycarboxylic acid esters, such as dialkyl esters of C₂- to C₄-dicarboxylic acid esters, such as ether esters, in particular alkyl glycol esters, such as, in particular, ethyl glycol acetate and methoxypropyl acetate, lactones, such as butyrolactone, phthalates, aldehydes or ketones, such as, in particular, methyl isoketone, cyclohexanone and acetone, acid amides, such as, in particular, dimethylformamide, N-methylpyrrolidone, nitromethane, triethylamine, sulfolane, nitrobenzene, formamide, dimethylsulfoxide, dimethylacetamide, quinoline, bromobenzene, aniline, anisole, acetonitrile, benzonitrile, thiophene and mixtures of the abovementioned solvents.

Ionic liquids or so-called supercritical liquids can moreover in principle also be employed. Water is also possible in the context of the present invention.

These dispersions can be prepared via the dispersing technologies known to the person skilled in the art, e.g. by the use of ultrasound, the use of bead or ball mills, dispersing by means of high pressure shear dispersers or dispersing in triple roll mills.

The dispersions prepared in this way have, in particular, a content of the nanoparticles of up to 2.5 mg per ml of dispersing agent and are still stable even after storage for three months or exposure to high pressure and shear in a fast-rotating centrifuge.

With the aid of these dispersing auxiliaries, all the known graphite-like nanoparticles can be dispersed readily and reliably. They are particularly suitable for dispersing single- or multi-layered, single-walled or multi-walled carbon nanotubes (CNT), carbon nanofibres in a fishbone or platelet structure or also nanoscale graphites or graphenes, such as are accessible e.g. from highly expanded graphites. They are very particularly suitable for dispersing carbon nanotubes.

According to the prior art, carbon nanotubes are understood as meaning chiefly cylindrical carbon tubes with a diameter of between 3 and 100 nm and a length which is several times the diameter. These tubes comprise one or more layers of ordered carbon atoms and have a core of different morphology. These carbon nanotubes are also called, for example, “carbon fibrils” or “hollow carbon fibres”.

Carbon nanotubes have been known for a long time in the technical literature. Although Iijima, Nature 354, 56-58, 1991 is generally named as the discoverer of nanotubes, these materials, in particular fibrous graphite materials with several layers of graphite, have already been known since the 70s and early 80s. Tates and Baker (GB 1469930A1, 1977 and EP 56004 A2) described for the first time the deposition of very fine fibrous carbon from the catalytic decomposition of hydrocarbons. Nevertheless, the carbon filaments produced on the basis of short-chain hydrocarbons are not characterized in more detail with respect to their diameter.

Conventional structures of these carbon nanotubes are those of the cylinder type. In the case of cylindrical structures, a distinction is made between the single-walled mono-carbon nanotubes (single wall carbon nano tubes) and the multi-walled cylindrical carbon nanotubes (multi wall carbon nano tubes). The usual processes for their production are e.g. arc processes (arc discharge), laser ablation, chemical deposition from the vapour phase (CVD process) and catalytic chemical deposition from the vapour phase (CCVD process).

Iijima, Nature 354, 1991, 56-8 discloses the formation of carbon tubes in the arc discharge process which comprise two or more layers of graphene and are rolled up to a seamless closed cylinder and nested in one another. Depending on the rolling up vector, chiral and achiral arrangements of the carbon atoms in relation to the longitudinal axis of the carbon fibres are possible.

Structures of carbon tubes in which an individual cohesive layer of graphene (so-called scroll type) or interrupted layer of graphene (so-called onion type) is the basis of the structure of the nanotubes were described for the first time by Bacon et al., J. Appl. Phys. 34, 1960, 283-90. The structure is called scroll type. Corresponding structures were also found later by Zhou et al., Science, 263, 1994, 1744-47 and by Lavin et al., Carbon 40, 2002, 1123-30.

Carbon nanotubes which can be employed in the context of the invention are all single-walled or multi-walled carbon nanotubes of the cylinder type, scroll type or with an onion-type structure. Multi-walled carbon nanotubes of the cylinder type, scroll type or mixtures thereof are preferably to be employed.

Particularly preferably, carbon nanotubes with a ratio of length to external diameter of greater than 5, preferably greater than 100 are used.

The carbon nanotubes are particularly preferably employed in the form of agglomerates, the agglomerates having, in particular, an average diameter in the range of from 0.05 to 5 mm, preferably 0.1 to 2 mm, particularly preferably 0.2-1 mm.

The carbon nanotubes to be employed particularly preferably essentially have an average diameter of from 3 to 100 nm, preferably 5 to 80 nm, particularly preferably 6 to 60 nm.

In contrast to the abovementioned known CNTs of the scroll type with only one continuous or interrupted graphene layer, CNT structures which comprise several graphene layers which are combined into a stack and rolled up (multi-scroll type) have also been found by the applicant. These carbon nanotubes and carbon nanotube agglomerates therefrom are the subject matter, for example, of the still unpublished German patent application with the application number 102007044031.8. The content thereof is also included herewith in the disclosure content of this application with respect to the CNT and their production. This CNT structure bears a relationship to the carbon nanotubes of the simple scroll type comparable to the relationship of the structure of multi-walled cylindrical mono-carbon nanotubes (cylindrical MWNT) to the structure of singe-walled cylindrical carbon nanotubes (cylindrical SWNT).

In contrast to the onion-type structures, the individual graphene or graphite layers in these carbon nanotubes, viewed in cross-section, evidently run continuously from the centre of the CNT to the outer edge without interruption. This can make possible e.g. an improved and faster intercalation of other materials in the tube skeleton, since more open edges are available as an entry zone for the intercalates compared with CNTs with a simple scroll structure (Carbon 34, 1996, 1301-3) or CNTs with an onion-type structure (Science 263, 1994, 1744-7).

The methods now known for the production of carbon nanotubes include arc discharge, laser ablation and catalytic processes. In many of these processes carbon black, amorphous carbon and fibres of high diameter are formed as by-products. In the catalytic processes, a distinction may be made between deposition on supported catalyst particles and deposition on metal centres formed in situ and having diameters in the nanometre range (so-called flow process). In the case of production via catalytic deposition of carbon from hydrocarbons which are gaseous under the reaction conditions (in the following CCVD; catalytic carbon vapour deposition), acetylene, methane, ethane, ethylene, butane, butene, butadiene, benzene and further carbon-containing educts are mentioned as possible carbon donors. CNTs obtainable from catalytic processes are therefore preferably employed.

The catalysts as a rule contain metals, metal oxides or decomposable or reducible metal components. For example, Fe, Mo, Ni, V, Mn, Sn, Co, Cu and further sub-group elements are mentioned as metals for the catalyst in the prior art. The individual metals indeed usually have a tendency to assist in the formation of carbon nanotubes, although according to the prior art high yields and low contents of amorphous carbons are advantageously achieved with those metal catalysts which are based on a combination of the abovementioned metals. CNTs obtainable using mixed catalysts are consequently preferably to be employed.

Particularly advantageous catalyst systems for the production of CNTs are based on combinations of metals or metal compounds which contain two or more elements from the series consisting of Fe, Co, Mn, Mo and Ni.

From experience, the formation of carbon nanotubes and the properties of the tubes formed depend in a complex manner on the metal component used as the catalyst or a combination of several metal components, the catalyst support material optionally used and the interaction between the catalyst and support, the educt gas and its partial pressure, an admixing of hydrogen or further gases, the reaction temperature and the dwell time or the reactor used.

A process which is particularly preferably to be employed for the production of carbon nanotubes is known from WO 2006/050903 A2.

In the various processes mentioned so far employing various catalyst systems, carbon nanotubes of different structures, which can be removed from the process predominantly as carbon nanotube powder, are produced.

Carbon nanotubes which are further preferably suitable for the invention are obtained by processes which are described in principle in the following literature references:

The production of carbon nanotubes with diameters of less than 100 nm is described for the first time in EP 205 556 B1. For the production, light (i.e. short- and medium-chain aliphatic or mono- or dinuclear aromatic) hydrocarbons and a catalyst based on iron, on which carbon carrier compounds are decomposed at a temperature above 800-900° C., are employed here.

WO86/03455A1 describes the production of carbon filaments which have a cylindrical structure with a constant diameter of from 3.5 to 70 nm, an aspect ratio (ratio of length to diameter) of greater than 100 and a core region. These fibrils comprise many continuous layers of ordered carbon atoms which are arranged concentrically around the cylindrical axis of the fibrils. These cylinder-like nanotubes have been produced by a CVD process from carbon-containing compounds by means of a metal-containing particle at a temperature of between 850° C. and 1,200° C.

WO2007/093337A2 has also disclosed a process for the preparation of a catalyst which is suitable for the production of conventional carbon nanotubes with a cylindrical structure. When this catalyst is used in a fixed bed, relatively high yields of cylindrical carbon nanotubes with a diameter in the range of from 5 to 30 nm are obtained.

A completely different route for the production of cylindrical carbon nanotubes has been described by Oberlin, Endo and Koyam (Carbon 14, 1976, 133). In this, aromatic hydrocarbons, e.g. benzene, are reacted on a metal catalyst. The carbon tubes formed show a well-defined, graphitic hollow core which has approximately the diameter of the catalyst particle and on which further less graphitically arranged carbon is found. The entire tube can be graphitized by treatment at a high temperature (2,500° C.-3,000° C.).

Most of the abovementioned processes (with an arc, spray pyrolysis or CVD) are used at present for the production of carbon nanotubes. However, the production of single-walled cylindrical carbon nanotubes is very expensive in terms of apparatus and proceeds with a very low rate of formation by the known processes, and often also with many side reactions which lead to a high content of undesirable impurities, i.e. the yield of such processes is comparatively low. The production of such carbon nanotubes is therefore also still extremely expensive industrially at present, and they are therefore employed above all in small amounts for highly specialized uses. However, their use for the invention is conceivable, but less preferred than the use of multi-walled CNTs of the cylinder or scroll type.

The production of multi-walled carbon nanotubes in the form of seamless cylindrical nanotubes nested into one another or also in the form of the scroll or onion structures described is at present carried out commercially in relatively large amounts predominantly using catalytic processes. These processes conventionally show a higher yield than the abovementioned arc and other processes and are at present typically carried out on the kg scale (a few hundred kilos/day worldwide). The MW carbon nanotubes produced in this way are as a rule somewhat less expensive than the single-walled nanotubes and are therefore employed e.g. as a performance-increasing additive in other materials.

The invention is explained in more detail in the following by the examples, which, however, do not represent a limitation of the invention.

### EXAMPLES

### Example 1

The synthesis of the dispersing auxiliary of the chemical formula I was carried out in accordance with equation 2.

For the first block, 4 g of methyl methacrylate, 84 mg of RAFT agent (4-cyano-4-methyl-4-thiobenzoylsulfanyl-butanoic acid) (M. Eberhardt, P. Theato, Macromol. Rapid Commun. 26, 1488, 2005) and 6.2 mg of AIBN (α,α′-azoisobutyronitrile) were dissolved in 6 ml of dioxane. The polymerization was carried out at 70° C. for 21 h. The polymer was purified by dissolving in THF and precipitation from hexane.

For the second block, 500 mg of the polymer, 1 mg of AIBN and pentafluorophenyl methacrylate (M. Eberhardt, R. Mruk, R. Zentel, P. Theato, Eur. Polym. J. 41, 1569-1575, 2005), 182 mg for P(MMA-b-PFPMA) 20, 364 mg for P(MMA-b-PFPMA) 40 and 542 mg for P(MMA-b-PFPMA) 60 were dissolved in 4 ml of dioxane. The polymerization was carried out at 70° C. for 40 h. The polymer was purified by dissolving in THF and precipitation from hexane. 465 mg of P(MMA-b-PFPMA) 20, 554 mg of P(MMA-b-PFPMA) 40 and 690 mg of P(MMA-b-PFPMA) 60 were obtained.

### Example 2

### Polymer-Analogous Reaction

50 mg of the polymer P(MMA-b-PFPMA) were mixed in two-fold excess with pyrenemethylamine hydrochloride and a three-fold excess of triethylamine in 2 ml of tetrahydrofuran (THF) The reaction was carried out at 45° C. for 12 h in a nitrogen atmosphere. By-products which precipitated out were separated off by centrifugation and decanting. The polymer was purified by precipitation from petroleum ether.

### Example 3

As Example 2 but with the use of 1-pyrenebutylamine hydrochloride instead of pyrenemethylamine hydrochloride.

| | MMA | Second | Anchor | Mn/ | Mw/ | |
|---|---|---|---|---|---|---|
| Name | units^{a} | monomer | groups^{b} | g/mol^{a} | g/mol^{a} | PDI^{a} |
| P(MMA-b-C1 | 140 | 40 | 13 | 18,400 | 19,900 | 1.08 |
| pyrene) 40 | | | | | | |
| P(MMA-b-C1 | 140 | 60 | 18 | 20,100 | 21,500 | 1.07 |
| pyrene) 60 | | | | | | |
| P(MMA-b-C4 | 140 | 20 | 5 | 15,700 | 17,600 | 1.12 |
| pyrene) 20 | | | | | | |
| P(MMA-b-C4 | 140 | 40 | 16 | 19,400 | 22,500 | 1.16 |
| pyrene) 40 | | | | | | |
| P(MMA-b-C4 | 140 | 60 | 20 | 20,800 | 28,300 | 1.36 |
| pyrene) 60 | | | | | | |

^{a}determined by GPC measurements,
^{b}determined by proton NMR spectroscopy.

| | MMA | Anchor | Weight | Chains/ | |
|---|---|---|---|---|---|
| Name | units^{a} | groups^{b} | loss/%^{c} | CNT^{c} | s/nm^{c} |
| P (MMA-b-C1 pyrene) 40 | 140 | 13 | 10.9 | 4,600 | 7 |
| P (MMA-b-C1 pyrene) 60 | 140 | 18 | 10.2 | 4,000 | 7.5 |
| P (MMA-b-C4 pyrene) 20 | 140 | 5 | 11.4 | 5,700 | 6.5 |
| P (MMA-b-C4 pyrene) 40 | 140 | 16 | 15.9 | 6,700 | 6 |
| P (MMA-b-C4 pyrene) 60 | 140 | 20 | 19.0 | 7,800 | 5.5 |

^{a}determined by GPC measurements,
^{b}determined by proton NMR spectroscopy,
^{c}determined from TGA measurements,
“s”: root from the area per polymer 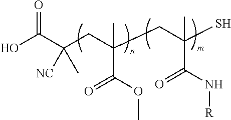
R:
—CH₂-pyrene P (MMA-b-C1-pyrene)
—(CH₂) ₄-pyrene P (MMA-b-C4-pyrene)

### Example 4

### Comparison Example

| | MMA | | Mn/ | Mw/ | |
|---|---|---|---|---|---|
| Name | units^{a} | Anchor groups^{b} | g/mol^{a} | g/mol^{a} | PDI^{a} |
| Pyrene-PMMA 90 | 90 | 1 | 8,90 | 10,500 | 1.18 |
| Pyrene-PMMA 180 | 180 | 1 | 18,100 | 23,700 | 1.31 |
| Pyrene-PMMA 270 | 270 | 1 | 27,200 | 36,700 | 1.35 |

^{a}determined by GPC measurements,
^{b}calculated from the amount of RAFT reagent added

| | MMA | Anchor | Weight | Chains/ | |
|---|---|---|---|---|---|
| Name | units^{a} | groups^{b} | loss/%^{c} | CNT^{c} | s/nm^{c} |
| Pyrene-PMMA 90 | 90 | 1 | 3.8 | 3,000 | 8.5 |
| Pyrene-PMMA 180 | 180 | 1 | 4.1 | 1,550 | 12 |
| Pyrene-PMMA 270 | 270 | 1 | 1.8 | 500 | 22 |

^{a}determined by GPC measurements,
^{b}calculated from the amount of RAFT reagent added,
^{c}determined from TGA measurements,
“s”: root from the area per polymer

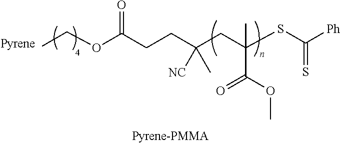

### Example 5

### Dispersions of CNTs in THF

P(MMA-b-C4-pyrene) 40 (2.3 mg/ml) in THF with 2.5 mg/ml of CNTs was treated with ultrasound (10 W for 15 min). The dispersion was stable even after centrifugation and standing for several weeks.

### Example 6

1 mg of graphene was dispersed with 1 mg of polymer P(MMA-b-C4 pyrene) 40 or P(MMA-b-C4 pyrene) 60 in 2 ml of chloroform (ultrasound, 10 W for 10 minutes). The dispersion was stable even after centrifugation and standing for several weeks.

### Example 7

### Comparison Example

1 mg of graphene was dispersed with 1 mg of pyrene-PMMA 90 in 2 ml of chloroform (ultrasound, 10 W for 10 minutes). The dispersion was unstable, and a sediment already formed after a few minutes.

1.-15. (canceled)

16. A method comprising dispersing graphite-like nanoparticles in a continuous liquid phase and introducing energy in the presence of a dispersing auxiliary, wherein the dispersing auxiliary is based on block copolymers, and wherein the block copolymers have polymer blocks E) without a side chain and at least one polymer block A) with side chains B) which comprise aromatic groups D) and are bonded to the main chain of block A) through aliphatic chain members C).

17. The method according to claim 16, wherein the block copolymer E) in the dispersing auxiliary is based on a polymer selected from the group consisting of vinyl polymers, polyesters, polyamides, polyurethanes, and mixtures thereof.

18. The method according to claim 17, wherein the vinyl polymer is selected from the group consisting of polyacrylates, polymethacrylates, polyacrylic acid, polystyrene, and mixtures thereof.

19. The method according to claim 16, wherein the length of the block A) with aromatic side chains B) in the dispersing auxiliary comprises at least five monomer units selected from the group consisting of vinyl polymers, polyesters, polyamides, polycarbonates, polyurethanes, and mixtures thereof.

20. The method according to claim 19, wherein the vinyl polymers are selected from the group consisting of polyacrylates, polymethacrylates, polyacrylic acid, and polystyrene.

21. The method according to claim 16, wherein the aromatic side chains B) in the dispersing auxiliary are based on at least one mono- or polynuclear aromatic D), and wherein the aromatics optionally contain hetero atoms.

22. The method according to claim 21, wherein the at least one mono or polynuclear aromatic D) comprises a C₅- to C₃₂-aromatic optionally substituted by amino groups.

23. The method according to claim 21, wherein the at least one mono or polynuclear aromatic D) comprises a C₁₀- to C₂₇-aromatic optionally substituted by amino groups.

24. The method according to claim 16, wherein the aliphatic chain members C) in the dispersing auxiliary are formed by a C₁- to C₁₀-alkyl chain.

25. The method according to claim 21, wherein the polynuclear aromatic D) is a pyrene derivate.

26. The method according to claim 17, wherein the polymer blocks E) of the dispersing auxiliary which are free from side chains are built up from 50 to 500 monomer units from acrylates or methacrylates.

27. The method according to claim 16, wherein the at least one polymer block A) of the dispersing auxiliary which contain side chains are built up from 5 to 100 monomer units from substituted acrylates or methacrylates.

28. The method according to claim 16, wherein the graphite-like nanoparticles have a diameter in the range of from 1 to 500 nm.

29. The method according to claim 16, wherein the graphite-like nanoparticles are single- or multi-layered graphite structures.

30. The method according to claim 29, wherein the single- or multi-layered graphite structures comprise graphenes or carbon nanotubes or mixtures thereof.

31. The method according to claim 16, wherein the continuous liquid phase is an organic solvent or water or a mixture thereof.

32. The method according to claim 31, wherein the organic solvent is a mono- or polyfunctional, straight-chain, branched or cyclic alcohols or polyols, aliphatic, cycloaliphatic or halogenated hydrocarbons, linear or cyclic ethers, esters, aldehydes, ketones or acids and amides and pyrrolidone

33. A dispersion of graphite-like nanoparticles obtained from the method according to claim 16.

34. A printable ink comprising the dispersion according to claim 33 and an organic solvent.

35. An electrically conductive structure or coating comprising the printable ink according to claim 34.
